(19) United States
(12) Patent Application Publication
(10) Pub. No.: US 2026/0066568 A1
(43) Pub. Date: Mar. 5, 2026

(54) Connector

(71) Applicant: Aptiv Technologies AG, Schaffhausen (CH)

(72) Inventors: Pedro Yabur Pacheco, Saltillo (MX); Maria Fernanda Amado Martinez, Saltillo (MX); Eduardo Gilberto Sena Carranza, Saltillo (MX); Jorge Ivan Escamilla Rodriguez, Saltillo (MX)

(21) Appl. No.: 19/037,799

(22) Filed: Jan. 27, 2025

Related U.S. Application Data
(60) Provisional application No. 63/688,949, filed on Aug. 30, 2024.

(51) Int. Cl. H01R 13/436

(52) U.S. Cl. CPC H01R 13/4364; H01R 2201/26

(57) ABSTRACT

An electrical connector lock member includes a body portion, a flexible tab, and a locking flange. The flexible tab extends from the body portion. The locking flange is disposed at an end of the flexible tab. The locking flange includes an arcuate surface configured to engage a locking wall of a connector body in a first position to suppress translation of the lock member in a first direction within a cavity of the connector body.

### CROSS-REFERENCE TO RELATED APPLICATIONS

This application claims the benefit of U.S. Provisional Application No. 63/688,949 filed Aug. 30, 2024, the entire disclosure of which is incorporated by reference.

### FIELD

The present disclosure relates to a lock member and more particularly to a connector assembly including a lock member having a locking flange that is configured to receive a progressively-increasing force.

### BACKGROUND

Modern vehicles (e.g., automobiles) rely on electrical wiring and electrical connections to facilitate communication between various electronic components within the vehicle. Connection systems (e.g., connectors and terminals) play an important role in ensuring the integrity of these electrical connections and the reliability and performance of the vehicle. Some connector assemblies use a connector body with module terminal-receiving bodies. In some situations, it is desirable to secure the position of the terminal-receiving bodies relative to the connector body to ensure proper alignment between the connector body, the terminal-receiving bodies, and the terminals. Current designs may require position assurance locks to secure the position of the connector body relative to the terminal-receiving bodies. While known position assurance locks for vehicle connection systems have proven acceptable for their intended purpose, a continuous need for improvement remains in the pertinent art to address the challenges associated with efficient locking of terminal-receiving bodies relative to connector bodies. For example, in some implementations, a primary lock reinforcement (PLR) may end up partially closed or fully closed due to transportation in bulk packaging, such that the PLR requires special packaging. For example, in some implementations, a blocking force of a PLR may end up lower than a preferred threshold of 30-45 N.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides an electrical connector lock member. The lock member includes a body portion, a flexible tab, and a locking flange. The flexible tab extends from the body portion. The locking flange is disposed at an end of the flexible tab. The locking flange includes an arcuate surface configured to engage a locking wall of a connector body in a first position to suppress translation of the lock member in a first direction within a cavity of the connector body.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an exploded view of an example connector assembly according to the principles of the present disclosure.

FIG. 2 is a perspective view of the connector assembly of FIG. 1 in an assembled configuration.

FIG. 3 is a perspective view of an example connector body of a connector assembly according to the principles of the present disclosure.

FIG. 4 is a perspective view of an example lock member of a connector assembly according to the principles of the present disclosure.

FIG. 5A is a cross-sectional perspective view of a connector assembly including a lock member in a first position according to the principles of the present disclosure, a portion of the connector assembly being removed for clarity.

FIG. 5B is a cross-sectional perspective view of a connector assembly including a lock member in a second position according to the principles of the present disclosure, a portion of the connector assembly being removed for clarity.

FIG. 6A-6C are cross-sectional views of various implementations of lock members according to the principles of the present disclosure.

FIG. 7A is a graph illustrating applied displacement versus engagement force for assembling lock members in a connector body according to the principles of the present disclosure.

FIG. 7B is a graph illustrating displacement of travel versus force for lock members according to the principles of the present disclosure.

In the drawings, reference numbers may be reused to identify similar and/or identical elements.

### DETAILED DESCRIPTION

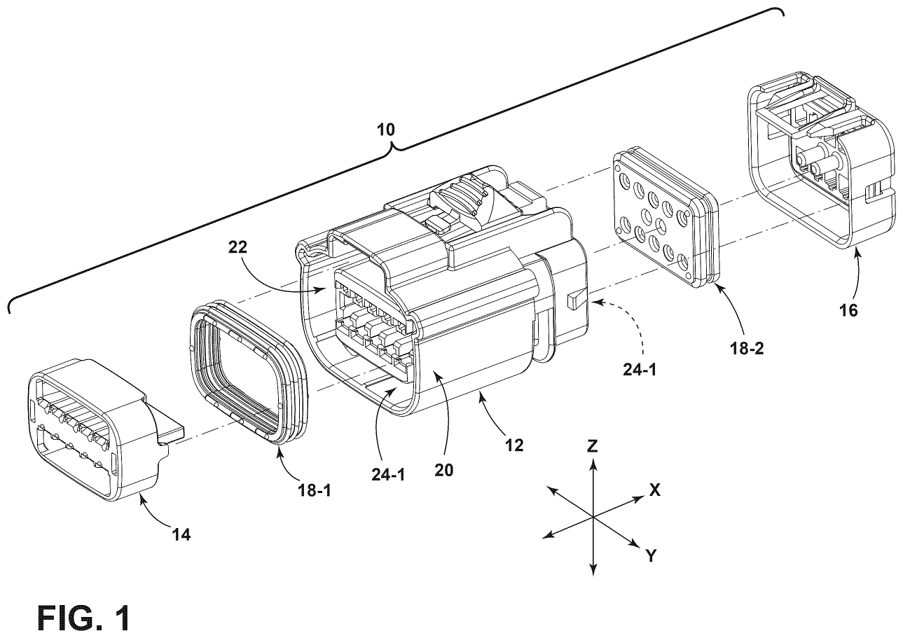

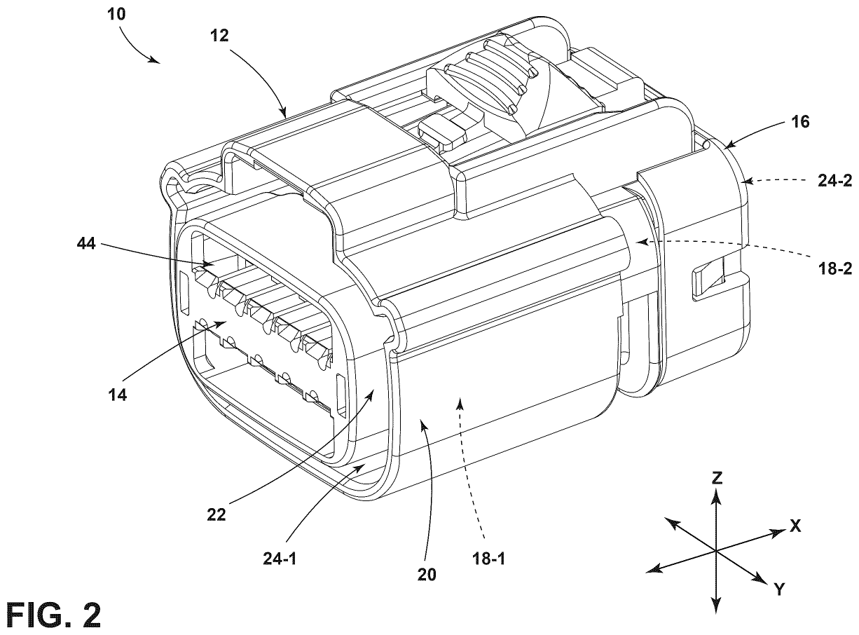

With reference to FIGS. 1 and 2, an example connector assembly 10 is shown. As will be explained in more detail below, the connector assembly 10 may be installed in a vehicle (e.g., an automobile) to facilitate the transmission of electricity between various electronic components within the vehicle. For example, the connector assembly 10 may be a female connector detachably coupled to a mating connector (e.g., a male connector, not shown) such that, during operation, of the vehicle, electricity is transmitted between the connector assemblies and to various electronic components within the vehicle.

In various implementations, the connector assembly 10 includes a connector body 12, a lock member 14 (e.g., a terminal position assurance (TPA) member), a cover 16 (e.g., seal retainer), a first seal 18-1 (e.g., a connector seal), and a second seal 18-2 (e.g., a cable seal), among others. The connector body 12 may include one or more walls 20 that define a cavity 22 (e.g., an opening or a recess), a first opening 24-1, and a second opening 24-2. The cavity 22 may be in communication with the first opening 24-1 and the second opening 24-2. In various implementations, the lock member 14, the first seal 18-1, the second seal 18-2, and/or at least portions of a plurality of terminals (not shown) are removably-disposed in the cavity 22. In an assembled configuration (e.g., FIG. 2), the first seal 18-1 may be removably-disposed in the first opening 24-1, the second seal 18-2 may be removably-disposed in the second opening 24-2, and the cover 16 may be removably-coupled to the connector body 12. At least a portion of the cover 16 may be disposed in the second opening 24-2.

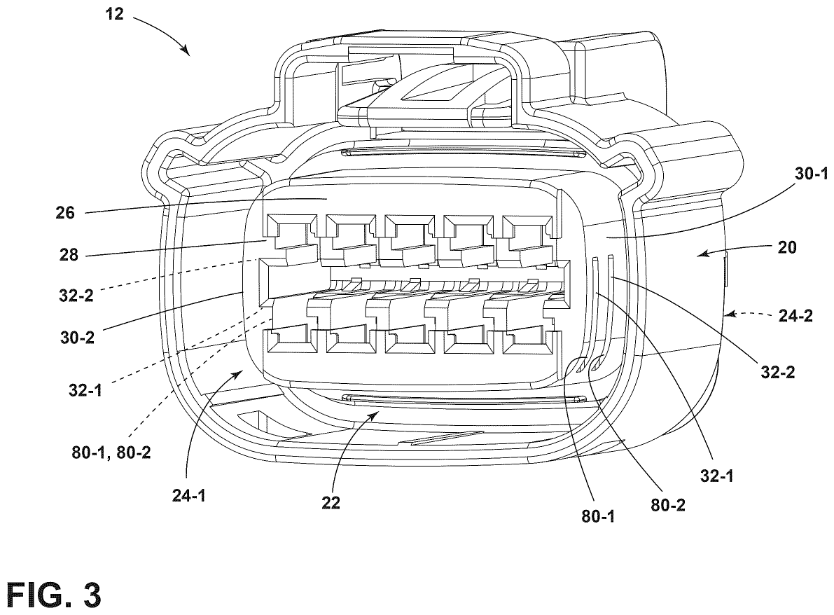

With reference to FIG. 3, an example connector body 12 is shown. The connector body 12 may comprise one or more of a variety of shapes, sizes, configurations, and/or materials. In various implementations, the connector body 12 includes an inner portion 26 disposed within the cavity 22 (e.g., opening or recess). The inner portion 26 may be coupled to at least one wall of the one or more walls 20. The inner portion 26 may define a plurality of apertures 28 (e.g., cavities). At least one of the apertures 28 may receive at least a portion of a terminal assembly (not shown).

In various implementations, the inner portion 26 includes a first sidewall 30-1 (e.g., a first locking wall) and a second sidewall 30-2 (e.g., a second locking wall) opposite the first sidewall 30-1. The first and second sidewalls 30-1, 30-2 may each define a first slot 32-1 and a second slot 32-2. The second slot 32-2 may be disposed adjacent to the first slot 32-1. As will be explained in more detail below, the first and second slots 32-1, 32-2 receive portions of the lock member 14 in the assembled configuration.

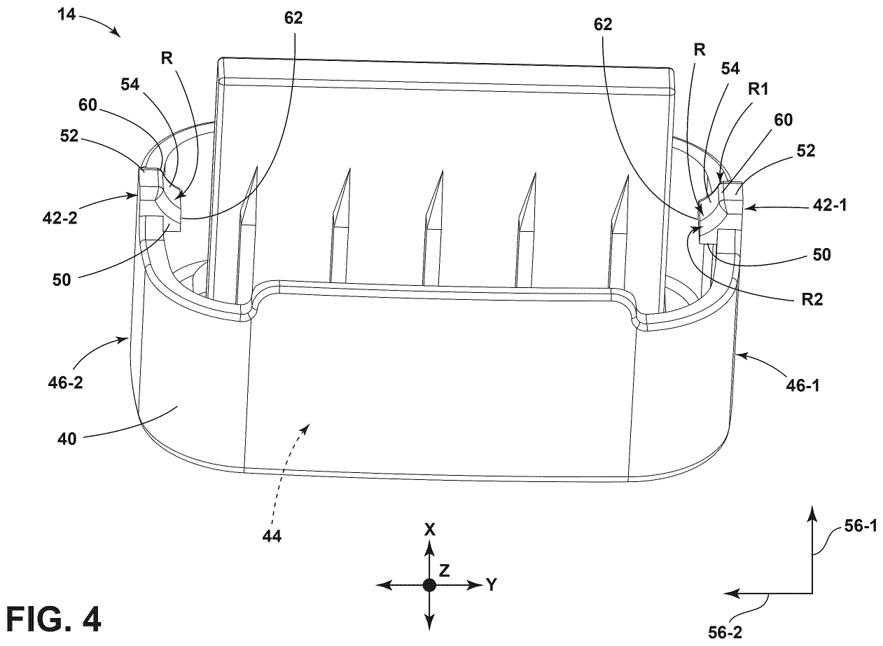

With reference to FIG. 4, an example lock member 14 is shown. The lock member 14 may comprise one or more of a variety of shapes, sizes, configurations, and/or materials. In various implementations, the lock member 14 includes a body portion 40, a first flexible tab 42-1, and a second flexible tab 42-2, among others. The body portion 40 may define a plurality of channels 44 (see, e.g., FIG. 2). At least one of the channels 44 may receive at least a portion of a terminal assembly (not shown).

In various implementations, the body portion 40 includes a first side 46-1 and a second side 46-2 opposite the first side 46-1. The first flexible tab 42-1 may extend from the first side 46-1 and the second flexible tab 42-2 may extend from the second side 46-2. In various implementations, the first and second flexible tabs 42-1, 42-2 each include a locking flange 50. The locking flange 50 may be disposed at an end 52 of a respective tab 42-1, 42-2. While the lock member 14 is generally depicted and described herein as including two flexible tabs 42, the lock member 14 may include more or less than two flexible tabs 42 within the scope of the present disclosure.

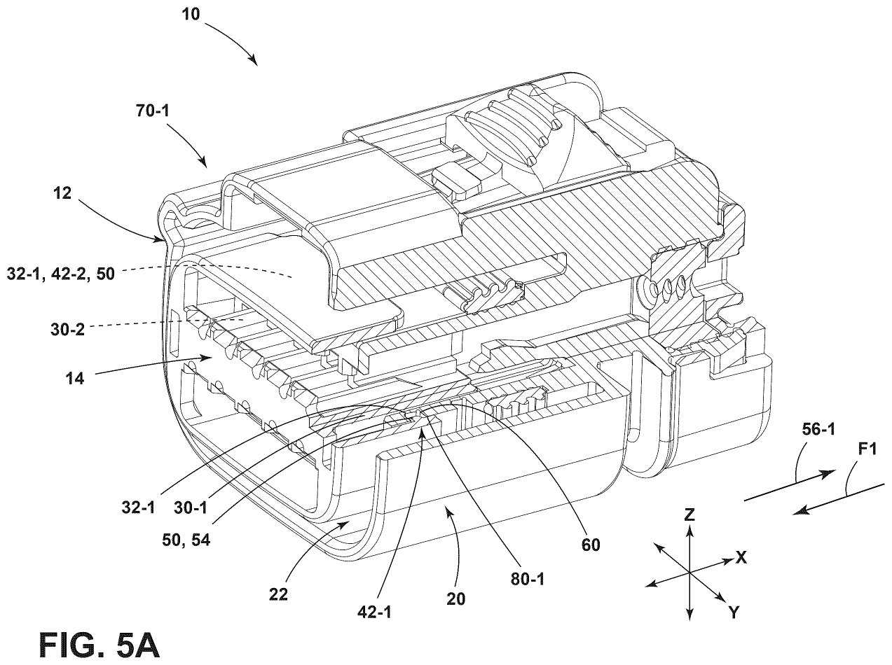

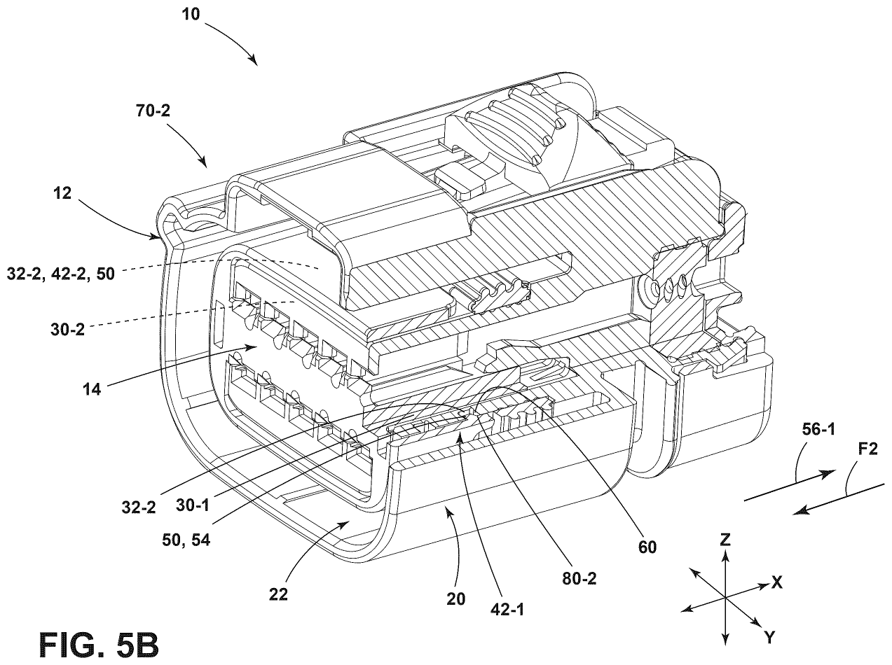

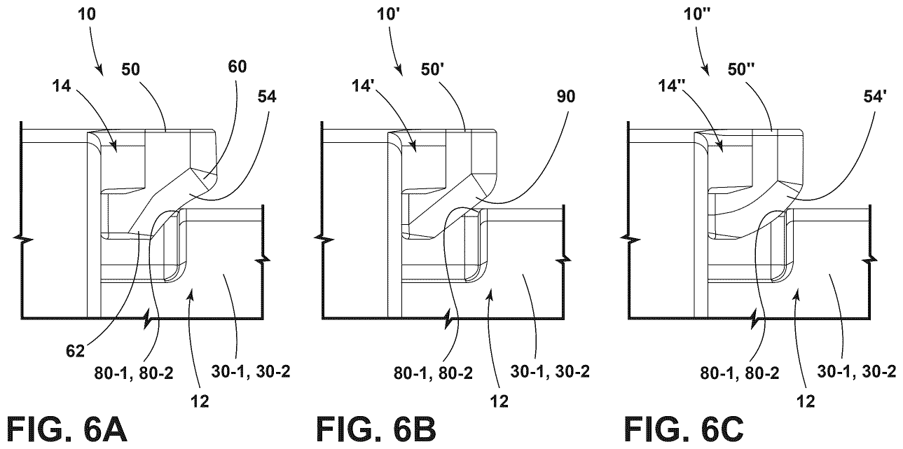

In various implementations, the locking flange 50 includes an arcuate surface 54. As illustrated in FIG. 5A, in the assembled configuration, the arcuate surface 54 engages portions (e.g., first sidewall 30-1, second sidewall 30-2, etc.) of the connector body 12. In some implementations, the arcuate surface 54 is concave (see, e.g., FIG. 6A). In some implementations, the arcuate surface 54 is convex (see, e.g., FIG. 6C).

In various implementations, the arcuate surface 54 defines a radius of curvature R. The radius of curvature R may be between 1.2 millimeters and 1.8 millimeters. The radius of curvature R may be substantially (e.g., ±10 percent) equal to 1.5 millimeters.

With reference to FIG. 4, in various implementations, the arcuate surface 54 defines a first radius of curvature R1 in a first plane extending in a first direction 56-1 (e.g., X-direction) and a second radius of curvature R2 in a second plane extending in a second direction 56-2 (e.g., Y-direction) transverse to the first direction 56-1. In various implementations, the arcuate surface 54 includes a proximal end 60 and a distal end 62 opposite the proximal end 60.

In response to the lock member 14 being inserted into the cavity 22, the lock member 14 may be moved (e.g., by a user, a machine, a tool, a robot, etc.) within the cavity 22 in the first direction 56-1 (e.g., X-direction). The lock member 14 may be moved to various locations within the cavity 22. For example, the lock member 14 may be moved to a first position 70-1 (e.g., a first pre-staged position). Subsequently, the lock member 14 may be moved from the first position 70-1 to a second position 70-2 (e.g., a second pre-staged position or a full-staged position).

With reference to FIG. 5A, the lock member 14 is shown in the first position 70-1 (e.g., a first pre-staged position). In the first position 70-1, the locking flange 50 of the first flexible tab 42-1 engages the first sidewall 30-1 (e.g., the first locking wall) of the connector body 12 and the locking flange 50 of the second flexible tab 42-2 engages the second sidewall 30-2 (e.g., the second locking wall) of the connector body 12 to suppress translation of the lock member 14 in the first direction 56-1 (e.g., X-direction) within the cavity 22 of the connector body 12.

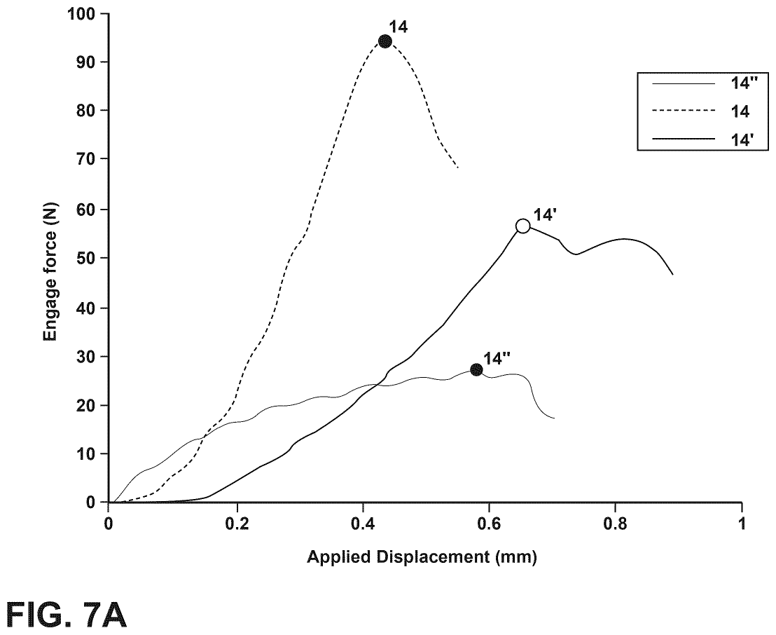

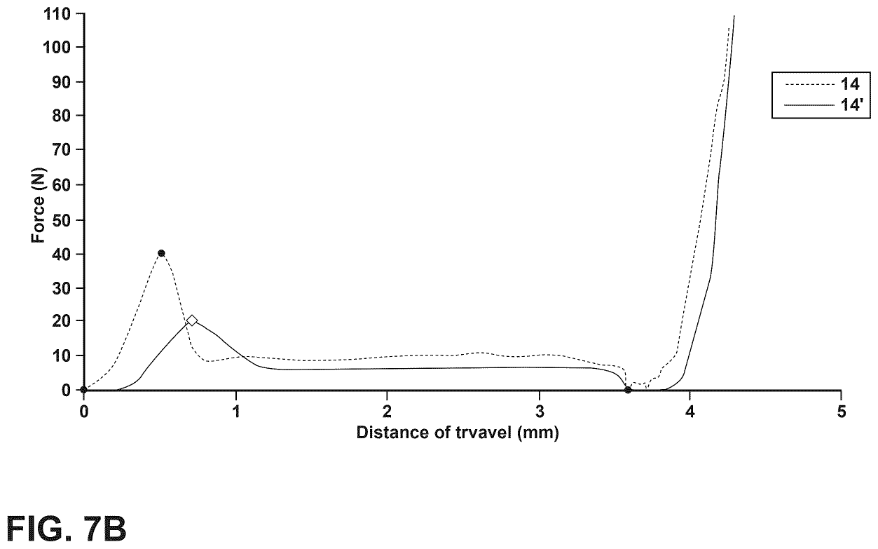

In various implementations, in the first position 70-1, the locking flange 50 of the first flexible tab 42-1 is disposed within the first slot 32-1 of the first sidewall 30-1 of the connector body 12 and the locking flange 50 of the second flexible tab 42-2 is disposed within the first slot 32-1 of the second sidewall 30-2 of the connector body 12. In various implementations, in the first position 70-1, each of the first and second sidewalls 30-1, 30-2 applies a first force F1 on an arcuate surface 54 of a locking flange 50 (e.g., on a proximal end 60 of the arcuate surface 54). For example, each of the first and second sidewalls 30-1, 30-2 includes a first edge 80-1 that is radiused or chamfered. The first edge 80-1 engages the arcuate surface 54 of a respective locking flange 50 in the first position 70-1 to inhibit translation of the lock member in the first direction 56-1 (e.g., X-direction) within the cavity 22. In various implementations, a sidewall (e.g., the first sidewall 30-1, the second sidewalls 30-2) applies an increasing force F1 on the arcuate surface 54 between the proximal end 60 and the distal end 62 as the lock member 14 translates in the first direction 56 within the cavity 22 (see, e.g., FIGS. 7A and 7B).

The connector assembly 10 may be shipped with the lock member 14 in the first position 70-1. As will be explained in further details below, the force required to move the lock member 14 within the connector body 12 may gradually increase with distance (e.g., in the X-direction) to improve the blocking force and avoid inadvertently closing the lock member 14 (e.g., moving the lock member 14 from the first position 70-1 to the second position 70-2). In turn, special packaging may not be required for the lock member 14 such that the connector assembly 10 can be shipped in bulk packaging.

With reference to FIG. 5B, the lock member 14 is shown in the second position 70-2 (e.g., a second pre-staged position or a full-staged position). In the second position 70-2, the locking flange 50 of the first flexible tab 42-1 engages the first sidewall 30-1 (e.g., the first locking wall) of the connector body 12 and the locking flange 50 of the second flexible tab 42-2 engages the second sidewall 30-2 (e.g., the second locking wall) of the connector body 12 to suppress translation of the lock member 14 in the first direction 56-1 (e.g., X-direction) within the cavity 22 of the connector body 12.

In various implementations, in the second position 70-2, the locking flange 50 of the first flexible tab 42-1 is disposed within the second slot 32-2 of the first sidewall 30-1 of the connector body 12 and the locking flange 50 of the second flexible tab 42-2 is disposed within the second slot 32-2 of the second sidewall 30-2 of the connector body 12. In various implementations, in the second position 70-2, each of the first and second sidewalls 30-1, 30-2 applies a second force F2 on an arcuate surface 54 of a locking flange 50 (e.g., on a proximal end 60 of the arcuate surface 54). For example, as illustrated in FIG. 6A, each of the first and second sidewalls 30-1, 30-2 includes a second edge 80-2 that is radiused or chamfered. The second edge 80-2 engages the arcuate surface 54 of a respective locking flange 50 in the second position 70-2 to inhibit translation of the lock member in the first direction 56-1 (e.g., X-direction) within the cavity 22. The first force F1 may be greater than the second force F2. The first force F1 may be less than the second force F2.

In various implementations, the lock member 14 is moved from the first position 70-1 to the second position 70-2 during assembly of the connector assembly 10. For example, in response to at least one terminal assembly (not shown) being coupled to the lock member 14, the lock member 14 may be moved from the first position 70-1 to the second position 70-2 to secure the terminal assembly within the connector body 12. Subsequently, the connector assembly 10 may be connected with the mating connector so that the terminal assembly is electrically connected with a corresponding terminal assembly of the mating connector.

With reference to FIG. 6A, a portion of the lock member 14 is shown during assembly with a connector body 12. In various implementations, an arcuate surface 54 of a locking flange 50 of the lock member 14 is concave. The arcuate surface 54 may engage an edge (e.g., a first edge 80-1, a second edge 80-2) of a sidewall 30-1, 30-2 of the connector body 12 during assembly of a connector assembly 10 (e.g., when the lock member 14 moves in a first direction 56-1 within a cavity 22 of the connector body 12).

With reference to FIG. 6B, a portion of a second lock member 14′ is shown during assembly with a connector body 12. It will be appreciated that the second lock member 14′ may be substantially similar to the lock member 14 excepts as otherwise described herein and/or shown in the drawings. The second lock member 14′ may include a locking flange 50′ that has a sloped (e.g., linear and/or planar) surface 90. The sloped surface 90 may engage an edge (e.g., a first edge 80-1, a second edge 80-2) of a sidewall 30-1, 30-2 of the connector body 12 during assembly of a connector assembly 10′ (e.g., when the second lock member 14′ moves in a first direction 56-1 within a cavity 22 of the connector body 12).

With reference to FIG. 6C, a portion of a third lock member 14″ is shown during assembly with a connector body 12. It will be appreciated that the second lock member 14″ may be substantially similar to the lock member 14 excepts as otherwise described herein and/or shown in the drawings. In various implementations, an arcuate surface 54′ of a locking flange 50″ of the third lock member 14″ may be convex. The arcuate surface 54′ may engage an edge (e.g., a first edge 80-1, a second edge 80-2) of a sidewall 30-1, 30-2 of the connector body 12 during assembly of a connector assembly 10″ (e.g., when the third lock member 14″ moves in a first direction 56-1 within a cavity 22 of the connector body 12).

With reference to FIG. 7A, a graph illustrating displacement of travel (e.g., in a first direction 56-1 within a cavity 22 of a connector body 12) versus force for assembling the lock member 14, the second lock member 14′, and the third lock member 14″ in a connector body 12 is shown. As shown, the lock member 14 requires more force to move within the cavity 22 (e.g., into and out of the first position 70-1) in comparison with the second and third lock members 14′, 14″. In some instances, it is preferable for the lock member 14 to require (e.g., meet or exceed) a threshold force (e.g., 30-45 N) to move out of the first position 70-1. This ensures that the lock member 14 remains securely in the first position 70-1 and is prevented from prematurely and unintentionally moving out of the first position 70-1 (e.g., during shipping or handling). The foregoing enables the components of the connector assembly 10 to be properly seated and connected during assembly of the connector assembly 10.

With reference to FIG. 7B, is a graph illustrating displacement of travel (e.g., in a first direction 56-1 within a cavity 22 of a connector body 12) versus force for the lock member 14 and the second lock member 14′ is shown. As shown, the lock member 14 requires more force to move within the cavity 22 (e.g., into and out of the first position 70-1) in comparison with the second lock member 14′.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The following Clauses provide an exemplary configuration for a connector as described above.
Clause 1: An electrical connector lock member comprising: a body portion; a flexible tab extending from the body portion; and a locking flange disposed at an end of the flexible tab, the locking flange including an arcuate surface configured to engage a locking wall of a connector body in a first position to suppress translation of the lock member in a first direction within a cavity of the connector body.
Clause 2: The electrical connector lock member of clause 1, wherein the arcuate surface is concave.
Clause 3: The electrical connector lock member of clause 1 or 2, wherein the arcuate surface is convex.
Clause 4: The electrical connector lock member of any of clauses 1 through 3, wherein the locking wall defines a slot, and wherein the flange is disposed within the slot in the first position.
Clause 5: The electrical connector lock member of clause 4, wherein the locking wall defines an additional slot disposed adjacent to the slot, and wherein the flange is disposed within the additional slot in a second position.
Clause 6: The electrical connector lock member of any of clauses 1 through 5, wherein the arcuate surface includes a proximal end and a distal end opposite the proximal end, and wherein: in the first position, the locking wall is configured to apply a first force on the proximal end of the arcuate surface in the first direction; and in a second position, the locking wall is configured to apply a second force on the proximal end of the arcuate surface in the first direction.
Clause 7: The electrical connector lock member of clause 6, wherein the first force is greater than the second force.
Clause 8: The electrical connector lock member of clause 6, wherein the first force is less than the second force.
Clause 9: The electrical connector lock member of clause 6, wherein the locking wall is configured to apply an increasing force on the arcuate surface between the proximal end and the distal end as the lock member translates in the first direction within the cavity.
Clause 10: The electrical connector lock member of any of clauses 1 through 9, wherein the arcuate surface defines a radius of curvature.
Clause 11: The electrical connector lock member of clause 10, wherein the radius of curvature is between 1.2 millimeters and 1.8 millimeters.
Clause 12: The electrical connector lock member of clause 10, wherein the radius of curvature is substantially equal to 1.5 millimeters.
Clause 13: The electrical connector lock member of any of clauses 1 through 12, wherein the locking wall includes an edge that is radiused or chamfered, and wherein the edge is configured to engage the arcuate surface in the first position to inhibit translation of the lock member in the first direction within the cavity.
Clause 14: The electrical connector lock member of any of clauses 1 through 13, wherein the arcuate surface defines a first radius of curvature in a first plane extending in the first direction, and a second radius of curvature in a second plane extending in a second direction transverse to the first direction.
Clause 15: The electrical connector lock member of any of clauses 1 through 14, further comprising: an additional flexible tab extending from the body portion; and an additional locking flange disposed at an end of the additional flexible tab.
Clause 16: The electrical connector lock member of clause 15, wherein: the body portion includes a first side and a second side opposite the first side, and the flexible tab extends from the first side and the additional flexible tab extends from the second side.
Clause 17: An electrical connector assembly comprising: the electrical connector lock member of any of clauses 1 through 16; and the connector body including a plurality of walls defining the cavity configured to receive the electrical connector lock member.
Clause 18: The electrical connector assembly of clause 17, wherein the connector body includes an inner portion disposed within the cavity.
Clause 19: The electrical connector assembly of clause 18, wherein the inner portion includes a first slot configured to receive the locking flange when the electrical connector lock member is in the first position.
Clause 20: The electrical connector assembly of clause 19, wherein the inner portion includes a second slot configured to receive the locking flange when the electrical connector lock member is in a second position.
Clause 21: A method of assembling an electrical connector assembly, the method comprising: providing a connector body defining a cavity, the connector body including a locking wall disposed within the cavity; providing a lock member including a body portion, a flexible tab extending from the body portion, and a locking flange disposed at an end of the flexible tab, the locking flange including an arcuate surface; engaging the arcuate surface with the locking wall to inhibit translation of the lock member within the cavity in a pre-staged position; and sliding the arcuate surface along the locking wall to translate the lock member within the cavity to a staged position.

1. An electrical connector lock member comprising:
a body portion;
a flexible tab extending from the body portion; and
a locking flange disposed at an end of the flexible tab, the locking flange including an arcuate surface configured to engage a locking wall of a connector body in a first position to suppress translation of the lock member in a first direction within a cavity of the connector body.

2. The electrical connector lock member of claim 1, wherein the arcuate surface is concave.

3. The electrical connector lock member of claim 1, wherein the arcuate surface is convex.

4. The electrical connector lock member of claim 1, wherein the locking wall defines a slot, and wherein the flange is disposed within the slot in the first position.

5. The electrical connector lock member of claim 4, wherein the locking wall defines an additional slot disposed adjacent to the slot, and wherein the flange is disposed within the additional slot in a second position.

6. The electrical connector lock member of claim 1, wherein the arcuate surface includes a proximal end and a distal end opposite the proximal end, and wherein:
in the first position, the locking wall is configured to apply a first force on the proximal end of the arcuate surface in the first direction; and
in a second position, the locking wall is configured to apply a second force on the proximal end of the arcuate surface in the first direction.

7. The electrical connector lock member of claim 6, wherein the first force is greater than the second force.

8. The electrical connector lock member of claim 6, wherein the first force is less than the second force.

9. The electrical connector lock member of claim 6, wherein the locking wall is configured to apply an increasing force on the arcuate surface between the proximal end and the distal end as the lock member translates in the first direction within the cavity.

10. The electrical connector lock member of claim 1, wherein the arcuate surface defines a radius of curvature.

11. The electrical connector lock member of claim 10, wherein the radius of curvature is between 1.2 millimeters and 1.8 millimeters.

12. The electrical connector lock member of claim 10, wherein the radius of curvature is substantially equal to 1.5 millimeters.

13. The electrical connector lock member of claim 1, wherein the locking wall includes an edge that is radiused or chamfered, and wherein the edge is configured to engage the arcuate surface in the first position to inhibit translation of the lock member in the first direction within the cavity.

14. The electrical connector lock member of claim 1, wherein the arcuate surface defines a first radius of curvature in a first plane extending in the first direction, and a second radius of curvature in a second plane extending in a second direction transverse to the first direction.

15. The electrical connector lock member of claim 1, further comprising:
an additional flexible tab extending from the body portion; and
an additional locking flange disposed at an end of the additional flexible tab.

16. The electrical connector lock member of claim 15, wherein:
the body portion includes a first side and a second side opposite the first side, and
the flexible tab extends from the first side and the additional flexible tab extends from the second side.

17. An electrical connector assembly comprising:
the electrical connector lock member of claim 1; and
the connector body including a plurality of walls defining the cavity configured to receive the electrical connector lock member.

18. The electrical connector assembly of claim 17, wherein the connector body includes an inner portion disposed within the cavity.

19. The electrical connector assembly of claim 18, wherein the inner portion includes a first slot configured to receive the locking flange when the electrical connector lock member is in the first position.

20. The electrical connector assembly of claim 19, wherein the inner portion includes a second slot configured to receive the locking flange when the electrical connector lock member is in a second position.
